(19) United States
(12) Patent Application Publication
(10) Pub. No.: US 2008/0317297 A1
(43) Pub. Date: Dec. 25, 2008

(54) Computer-Based Facial Paralysis Assessment

(75) Inventors: Richard Daniel Willmann, Siegburg (DE); Gerd Lanfermann, Aachen (DE); Jan Kneissler, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V.

(21) Appl. No.: 12/158,060

(22) PCT Filed: Nov. 27, 2006
(86) PCT No.: PCT/IB06/54440

§ 371 Date: Jun. 19, 2008

(30) Foreign Application Priority Data
Dec. 21, 2005 (EP) 05112547.4
Feb. 21, 2006 (EP) 06110189.5

(51) Int. Cl. G06K 9/00

(52) U.S. Cl. 382/118

(57) ABSTRACT

A computer-based system is presented for grading facial paralysis, which system is adapted to be operated by a patient, including a camera system for collecting a series of images of the patient's face for analysis by a computer system, and a display which provides visual feedback to the patient so that the computer system can prompt the patient to carry out specific movements or facial exercises. This system is applicable for use in a home environment by a patient.

This invention relates to a computer-based system for assessing facial paralysis, which is particularly adapted for use by untrained personnel. In particular, it is adapted to be used in a stroke rehabilitation system to deal with disabilities caused by stroke.

A typical known computer-based system for assessment of facial paralysis includes a camera which is used to detect facial expressions, and requires a strictly controlled environment with the patient accurately positioned relative to the camera and supervised by a clinical professional. Otherwise it is not possible to obtain consistent results, since variations in the patient's position or attitude relative to the camera will, of course, influence the resulting camera image.

In order to assess and grade the facial paralysis of a patient, various methods have been used in order to obtain an objective measurement of standard expressions such as smiling, whistling, or raising the eyebrows. Since the symmetry of movement in the two halves of the face is used as the indicator for facial paralysis, it is crucial to be able to separate the motion of the facial muscles from the motion of the complete head. Consequently, several methods have been proposed for achieving this in the past. For example, markers can be manually placed in standard positions on the face of the patient, and a series of photographs taken during the patient's changes of facial expression are compared in order to make the necessary assessment. Other systems involve fixing the patient's position by means of a clamping device, for example, or alternatively, having the patient wearing a helmet camera, so that movement of the patient's head does not affect the photographic results. Thus, methods of this kind require either the specialized skill of an operator in order to properly place the markers on the patient's face, or some kind of special apparatus designed to restrict or compensate for the patient's movement, so that none of the prior proposals are suitable for use as a primary health care solution at home.

For example, WO 92/03801 (University of Oklahoma) describes a system of assessing motion of a body part such as an individual's face, using a computerized system including a video camera in which different methods of allowing for, or preventing, movement of the subject relative to the camera, are discussed in some detail. In particular, this application describes the use of marker dots on the face of the patient, or a head holder for securing the patient's head in a desired position.

Accordingly, the present invention provides a computer-based system for grading facial paralysis which is adapted to be operated by a patient, including a camera system for collecting a series of images of the patient's face for analysis by a computer system, and a display which provides visual feedback to the patient so that the computer system can prompt the patient to adjust the position of their face in a suitable manner, relative to the camera, and to carry out specific facial exercises.

In one embodiment of the invention, the system comprises a camera which can be mounted in a optimum position to enable it to capture images of the user's face while the user is viewing a monitor of the computer and the images are displayed on the monitor. A visible indication, such as a small image box or frame, is also provided to enable the user to adjust his position suitably so that his face fits in the desired field. In this embodiment the camera is preferably adapted to be mounted centrally on top of the monitor to facilitate proper alignment with the user.

Preferably, the system is provided with a user interface which combines vision and speech-based means of communicating with the patient, so as to instruct him or her to correct their position and to perform the required exercises, to enable the system to make the proper grading of the patient's degree of paralysis.

If the camera is arranged on the computer monitor, it is preferably provided with a zoom facility, at least, to enable the size of the image of the patient's face to be adjusted.

Preferably, the camera system is provided with a pan/tilt/zoom facility, so as to enable both the relative size and position of the patient's head to be suitably adjusted, without requiring a very high degree of accurate positioning of the camera, or the patient's head, or fine adjustment of the position in use. This is particularly useful if the camera is separately mounted from the monitor. In any case, the system preferably includes an arrangement for automatically controlling the camera zoom, so as to adjust the scale and resolution of the image of the detected face, to match the system requirements.

Preferably, the system is so arranged as to detect specific facial features in the region of the patient's face, especially the outer corners of the eyes and the tip of the nose, in order to normalize the image to a standard size and orientation, and to define a symmetry line in the face to enable any asymmetry of facial movements to be computed. In this connection, it will be appreciated that, because of the differences in geometry of the faces of various patients, it is necessary to detect details of the facial features, as well as the overall size and position of the head, in order to obtain an accurate result.

Accordingly, a preferred embodiment of the invention provides a system for assessing the degree of facial paralysis of a patient, comprising a camera for capturing a sequence of images of the face during specified movements or exercises, to a processing unit, the system including optical, mechanical and/or digital means to allow adjustment of position and scale of the patient's face; a display for providing visual feedback to the patient, means for detecting a face included in the image, and means for identifying facial features in the image, in order to normalize the image to a standard size and orientation, by adjusting the camera position and zoom controls; and means for analyzing the flow of movement in the image, the processing unit being adapted to analyze the sequence of images in order to produce a resultant grading.

Preferably, the system further comprises means for detecting whether the patient's face is rotated out of the image plane, in order to provide corresponding instructions to the patient, to correct their position, and means for detecting whether a requested facial movement has been completed, in order to check the user's compliance with the instructions from the system.

In use, the results of the detection process are used to produce a parameter vector describing the recorded movement, and a classifier for the parameter vector supplies the patient, and their medical professional, with a grading of the degree of facial paralysis.

One embodiment of the invention will now be described by way of example, with reference to the accompanying drawings in which:

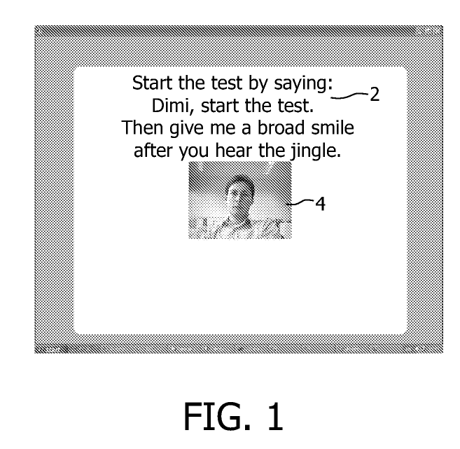

FIG. 1 shows a computer screen display showing the system in use;

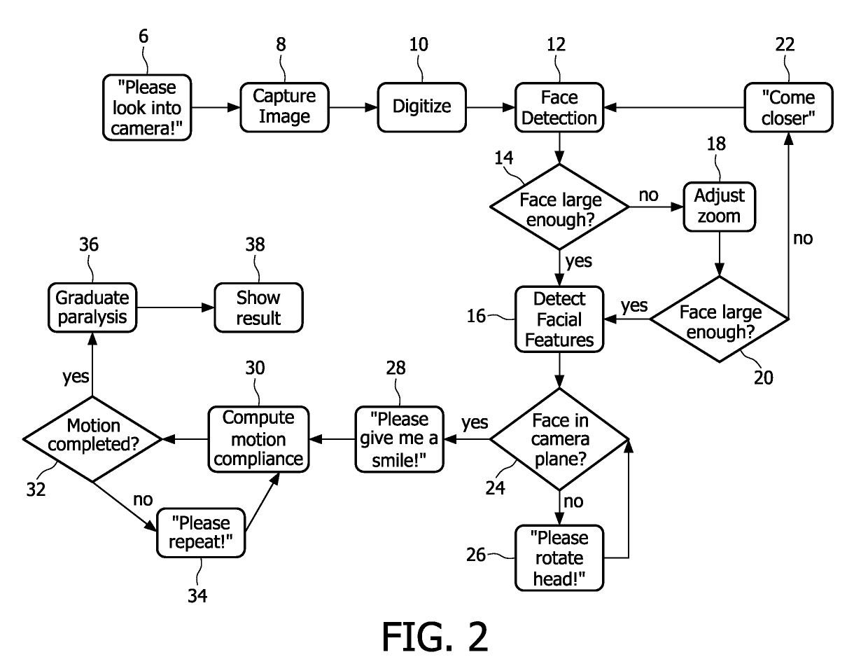

FIG. 2 is a flow chart of the operation of the system;

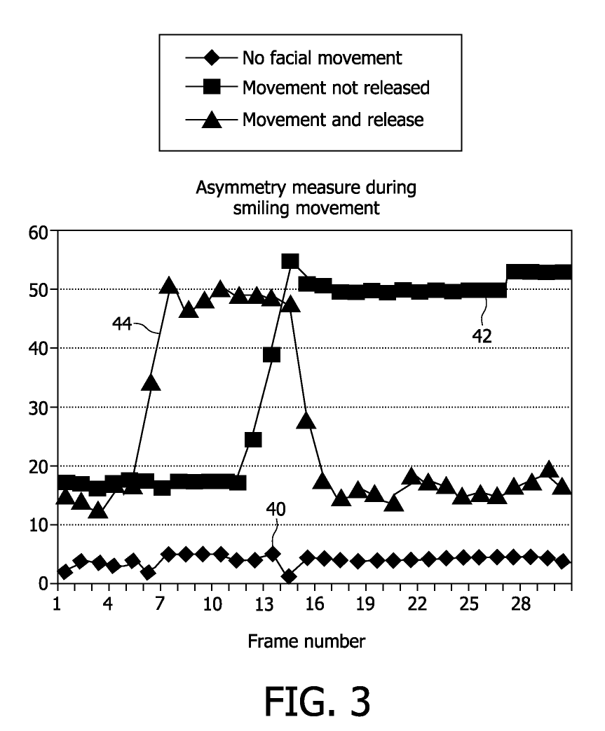

FIG. 3 is a chart showing an asymmetry measurement during smiling movement.

The apparatus required to operate the system comprises a computer, and a zoom video camera which is adapted to be mounted on or adjacent the computer display, so as to enable the user to operate the system himself, while facing the computer display unit. The computer preferably has a sound output capability, and preferably also, a voice recognition system to allow it to be controlled by voice commands from the patient. In one embodiment (not shown) the camera is separately mounted on a motorized pan/tilt unit controlled by the computer.

FIG. 1 shows a resultant display, at the start of operation of the system, which comprises a series of text instructions, as well as the initial image of the user facing the camera, which is not shown in the Figure. It will be appreciated that the instructions may be displayed on the screen or produced as speech output from a computer and in the following description, it will be understood that either or both of these methods may be used at various stages of the procedure.

FIG. 2 illustrates the overall mode of operation of the system, which begins by giving a prompt which is shown on the display, and may also be spoken by a speech synthesizer, as indicated at 6, requesting the patient to look into the camera. It will also be understood that the system may be provided with voice recognition means so that it can be operated by voice commands from the user. The image is then captured (8), digitized (10) and subjected to a face detection procedure (12).

If the subject's face appears to be approximately large enough (14) the processing proceeds to step 16 at which facial features are detected. In particular the outer corners of the eyes, and the tip of the nose, provide good reference points which form a stable triangle regardless of expression. Accordingly, these can be compared with a standard reference triangle to establish the exact size and position of the face. If not, the camera zoom is adjusted (step 18) and if it is then large enough (step 20) the facial feature detection step 16 can be attempted again. If it is still not large enough, the process branches to step 22 where the patient will be prompted to come closer, and the face detection procedure will then begin again at 12.

Once the facial features have been successfully detected, the process proceeds to step 24 at which the orientation of the face, relative to the camera plane is detected and if it is determined that the plane of the face is not aligned with the camera plane, a message is displayed (26) requesting that the patient's head be rotated appropriately.

Once the orientation of the face has been suitably corrected, a further message is displayed, asking the patient to carry out an action to form a particular facial expression, such as a smile (step 28) and the flow of action is followed (step 30) to detect whether the appropriate motion has been completed (step 32). If it appears that a suitable motion has not been completed, a message will be displayed requesting that the motion is repeated (step 34), and once the motion has been appropriately completed, the degree of paralysis can be analyzed (step 36) and the result displayed (step 38).

The analysis is carried out, by computing a vector of asymmetry measures, and this is compared to data from a group of stroke victims and a healthy control group, in order to grade the user's performance. The historical data of the performance of the user is stored in a database, so that a chart can be generated, showing the user's progress. This personalized analysis allows rehabilitation success to be graded, as well as allowing reliable detection of relapse or recurrences/events.

FIG. 3 illustrates some typical measurements of asymmetry during a smiling movement, in which the lower plot (diamond shaped markers) indicated by reference 40 shows a series of measurements in which no facial movement is detected. The part of squares 42, on the other hand indicate a facial movement in which the requested expression is achieved, but not subsequently released, while plot 44, indicated by a series of triangles, shows a normal facial movement and release, as would be expected from a healthy control group.

It will also be appreciated that the invention can be embodied in a somewhat simplified system requiring a minimum of positioning adjustment by the user, if the camera is mounted centrally on the top of the computer monitor. The user will then arrange him or herself so that their face is shown suitably framed on an image of the display and the system will proceed with face detection as outlined above. If necessary, optical or digital zooming may be employed to adjust the scale of the face image, and digital processing may also be applied to the image to improve image quality.

It will also be appreciated that the invention may be implemented by means of a “server-side” processing arrangement with the user having a thin-client application running on his own computer. For example the thin-client could be a “Javascript” application running in a web-browser which is arranged to access a server carrying the main application program, and a database of patient information via the internet or a LAN.

1. A computer-based system for grading facial paralysis which is adapted to be operated by a patient, including a camera system for collecting a series of images of the patient's face for analysis by a computer system, and a display which provides visual feedback to the patient so that the computer system can prompt the patient to carry out specific movements or facial exercises.

2. A system according to claim 1 in which the system is arranged to display an image field or frame so that in use, the patient can adjust their position to fit the field or frame.

3. A system according to claim 1 in which the system includes optical or mechanical and/or digital adjustment means to enable the scale or perspective of the image to be adjusted, so that the image is formed in a desired relationship to the display.

4. A computer-based system according to claim 1 for grading facial paralysis comprising a camera for capturing a sequence of images of the face during specified movements or exercises, to a processing unit, the system including optical, mechanical and/or digital means to allow adjustment of position and scale of the patient's face; a display for providing visual feedback to the patient, means for detecting a face included in the image, and means for identifying facial features in the image, in order to normalize the image to a standard size and orientation, by adjusting the camera position and zoom controls; and means for analyzing flow of movement in the image, the processing unit being adapted to analyze a sequence of images in order to produce a resultant grading.

5. A system according to claim 4 in which the means for identifying facial features is adapted to detect outer corners of eyes, and tip of a nose, and to compare them with a reference in order to establish a position and orientation of the face.

6. A system according to claim 4 in which the processing unit comprises means for detecting whether the patient's face is rotated out of the image plane, in order to determine whether the patient is in a desired position, and means for detecting whether a requested facial movement has been completed, in order to check the user's compliance with instructions from the system.

7. A system according to claim 1, further comprising a speech-based interface for communicating with the patient.

8. A system according to claim 1 further comprising means for storing data relating to a group of stroke victims and a healthy control group; means for grading a current user's performance by comparison with the stored data and for storing a series of results in a database, and means for grading the user's progress by comparing the stored results.
